(19) United States
(12) Patent Application Publication
(10) Pub. No.: US 2021/0112176 A1
(43) Pub. Date: Apr. 15, 2021

(54) METHODS AND SYSTEMS FOR GENERATING MIXED RASTER CONTENT (MRC) FILE

(71) Applicant: XEROX CORPORATION, Norwalk, CT (US)

(72) Inventors: Sainarayanan Gopalakrishnan, Chennai (IN); Rajasekar Kanagasabai, Chennai (IN); Vignesh Doss, Palanichettipatti (IN)

(73) Assignee: XEROX CORPORATION, Norwalk, CT (US)

(21) Appl. No.: 16/599,149

(22) Filed: Oct. 11, 2019

(51) Int. Cl. H04N 1/32; H04N 1/387; H04N 1/393

(52) U.S. Cl. CPC H04N 1/32475; H04N 1/393; H04N 1/3871

(57) ABSTRACT

The present disclosure discloses methods and systems for generating a mixed raster content (MRC) format file for a single background color image document. The method includes receiving an input document at an image capturing device. The input document is segmented into an image layer and a text layer. Then, image content in the image layer is determined. Upon an affirmative determination, a new image layer is generated by adding the determined image content to a white background image layer using a morphological operation. The text layer and the new image layer is compressed using respective compression schemes. The compressed text layer and the new image layer are integrated to generate image data in the MRC file format. The generated image data is stored in a memory device.

### TECHNICAL FIELD

The present subject matter relates generally to mixed raster content (MRC) imaging systems and more particularly to a method and a system for generating an MRC file format for a single color background.

### BACKGROUND

In printing technology, scanning, exporting, and storing of color images in a printing network have started to become the standard features offered by digital multifunction devices. For such standard features, the file size of an image document is an important factor. The file size of the image document that needs to be exported or stored is nowadays optimized using different available compression schemes and/or file formats. One of the popular compression schemes/file formats that are currently being offered is Mixed or Multiple Raster Content (MRC) file formats. The MRC file format provides a way to achieve high image quality with small file size.

The MRC file format is generated by segmenting the image document (such as image file including mixed content such as text and pictorial/image data) into two or more layers including, for example, image layer (background layer) and text layer (foreground layer). Segmentation of the image document into the layers tends to improve compression of the image document, and also allows different compression methods to be applied to the different layers. For example, it is generally known in the art that the MRC compression scheme implements JPEG compression to the image layer and JBIG2 compression to the text layer, in order to manipulate and compress the image document.

However, it is generally known that in the MRC compression scheme, some of the text regions will be misclassified as image region due to segmentation failures. This will introduce JPEG compression blocking artifacts near the text regions. This further creates noisy appearance around the text regions. These noises will be also contributing to an increase in the file size. Accordingly, there is a need for a method of and a system for generating an MRC file format having a mechanism to reduce the noises around the text regions.

### SUMMARY

According to aspects illustrated herein, a method for generating a mixed raster content (MRC) format file is disclosed. The method includes receiving an input document at an image capturing device. Upon receipt of the input document, the input document is segmented into an image layer and a text layer. Then, a determination is made for image content in the image layer. Upon an affirmative determination, a new image layer is generated by adding the determined image content to a white background image layer using a morphological operation. The new image layer and the text layer are then compressed using respective compression schemes. Thereafter, the compressed layers are integrated to generate image data in the MRC file format. The generated image data is then stored in a memory device.

According to further aspects illustrated herein, an image processing system implementing the subject matter includes an image capturing device, a processor coupled to the image capturing device, a segmentation module coupled to the processor, and a compression module coupled to the processor. The image capturing device is to receive an input document. The segmentation module coupled to the processor is to segment the input document into an image layer and a text layer. Thereafter, the compression module is to: determine image content in the image layer; upon affirmative determination, generate a new image layer by adding the determined image content to a white background image layer using a morphological operation; compress the new image layer with the text layer using respective compression schemes; integrate the compressed text layer and the new image layer to generate image data in the MRC file format; store the generated image data in a memory device.

According to additional aspects illustrated herein, a non-transitory computer-readable medium implementing the subject matter includes instructions executable by a processing resource. The instructions are executed by the processing resource to: receive an input document; segment the input document into an image layer and a text layer; determine image content in the image layer; upon affirmative determination, generate a new image layer by adding the determined image content to a white background image layer using a morphological operation; compress the text layer and the new image layer using respective compression schemes; integrate the compressed the text layer and the new image layer to generate an image data in the MRC file format; and store the generated image data in a memory device.

Other and further aspects and features of the disclosure will be evident from reading the following detailed description of the embodiments, which are intended to illustrate, not limit, the present disclosure.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The illustrated embodiments of the subject matter will be best understood by reference to the drawings, wherein like parts are designated by like numerals throughout. The following description is intended only by way of example, and simply illustrates certain selected embodiments of devices, systems, and processes that are consistent with the subject matter as claimed herein.

FIG. 1 illustrates an image processing system as per an implementation of the present subject matter.

FIG. 2 illustrates the image processing system in detail as per an implementation of the present subject matter.

FIG. 3 illustrates an MRC compression scheme according to an implementation of the present subject matter.

FIGS. 4A-4F illustrate an implementation of the MRC compression scheme according to an implementation of the present subject matter.

FIG. 5 illustrates a table representing the file size comparison between the conventional and proposed MRC compression scheme.

FIGS. 6A-6B show output according to conventional approach. FIGS. 7A-7B show output according to the present disclosure/approach.

FIG. 8 illustrates a networking environment for the image processing system in accordance with the present subject matter.

FIGS. 9A-9B illustrate a method of implementing the various processes of the image processing system.

### DETAILED DESCRIPTION

A few inventive aspects of the disclosed embodiments are explained in detail below with reference to the various figures. Embodiments are described to illustrate the disclosed subject matter, not to limit its scope, which is defined by the claims. Those of ordinary skill in the art will recognize a number of equivalent variations of the various features provided in the description that follows.

### Non-Limiting Definitions

Definitions of one or more terms that will be used in this disclosure are described below without limitations. For a person skilled in the art, it is understood that the definitions are provided just for the sake of clarity and are intended to include more examples than just provided below.

“Image data” refers to a pattern of physical light captured or generated at a user device including workstations, personal computers, personal digital assistants (PDAs), laptop computers, notebooks, smartphones, and the like. The image data may include fill objects such as characters, words, text, and other objects such as graphics, photos, etc. The image data may be included in a set of one or more input images, such as in input images of the pages of a document. The input image may be divided into segments, objects, or structures, each of which is itself an image. A segment, object, or structure of the input image may be of any size up to and including the whole input image.

“Image capturing device” may be an input device. The image capturing device may be any type of device for receiving the image data. Examples of the image capturing device may include, but not limited to, a scanning device, a facsimile device, a computing device, a storage device, and the like.

“Processor” may be a single dedicated processor, a single shared processor, or a plurality of individual processors, some of which may be shared. Moreover, explicit use of the term “processor” should not be construed to refer exclusively to hardware capable of executing software, and may implicitly include, without limitation, digital signal processor (DSP) hardware, network processor, application specific integrated circuit (ASIC), field programmable gate array (FPGA), read-only memory (ROM) for storing software, random access memory (RAM), non-volatile storage. Other hardware, conventional and/or custom, may also be included.

“Mixed or Multiple Raster Content (MRC) file format” is a format storing compressed images into at least two components, namely text layer component and an image layer. By storing the images into two different components, the most efficient and accurate compression algorithms can be used for each type of the components.

“Image layer” is one of the layer components stored in the MRC file format. Image layer may be used for storing continuous-tone (i.e., contone) information, such as background attributes of an image, like pictures and/or smoothly varying background colors.

“New image layer” is an image layer generated by applying morphological operations on white background image layer having black color image content.

“Text layer” is one of the layer component stored in the MRC file format. Text layer may hold the color information corresponding to the corresponding text and/or line art found in the text layer.

“Printer” may be defined as including, but not necessarily limited to, a peripheral that produces a representation of a document on one or both sides of media such as paper, plastic sheet, fabric, etc. A printer can be a single function device or multi-function (e.g., including scanning, faxing, or other functionality) device. The printer may include software, hardware, firmware, or combination thereof. Further, the printer can use any of a variety of different types of marking technologies such as a laser, inkjet, dye-sublimation, off-set printing, thermal printing, impact printing, etc. As used herein, the terms “render” and “rendering” are defined as including, but not necessarily limited to, taking print data such as text, images, graphics, etc., and converting them into a ready to print (RTP) format that is compatible with a destination printer. “Image scanner” often abbreviated to the just scanner. Although the term is ambiguous out of context (barcode scanner, CAT scanner, etc.), the image scanner is a device that optically scans images, printed text, handwriting or an object and converts it to a digital image. “Image reader” is a computer program that can display stored graphical images. The image reader can often handle various graphics file formats. Such computer program or reader usually renders the image according to properties of the display such as color depth, display resolution, and color profile. “Document generator” is a programming tool that generates software documentation intended for programmers (API documentation) or end users, or both, from a set of especially commented source code files, and in some cases, binary files.

“Computer-readable medium” or “storage medium” may be a physical medium that can store data. Examples of “computer-readable medium” may include a magnetic medium such as diskettes, floppy disks, and tape; an optical medium such as laser disks and CD-ROMs; and semiconductor media such as semiconductor ROMs and RAMs. As used herein, “storage medium” covers one or more distinct units of a medium that together store a body of data. For example, a set of floppy disks storing a single body of data may together be storage medium.

### Overview

Various exemplary implementations of a method and a system according to this disclosure process an image data of a document to produce highly-compressed image data files that accurately capture the original document content and provide optimal file size and image quality balance for processing and output of the image data. File size and quality are some factors that users face when compressing and exporting color images using digital multifunction devices and printers. Apart from offering different resolutions, different compression schemes are being offered in these devices as well.

Various method(s) and system(s) of the present subject matter described herein allow generation of a Mixed or Multiple Raster Content (MRC) file format. The method begins with receipt of an input document having image data including a plurality of pixels. The image data may be received as the input document by, for example, an image capturing device, or retrieved from storage or memory. In an example, the image capturing device may be an input device. The image capturing device may be any type of device for receiving input image data. Example, of the image capturing device, may include, but not limited to, a scanning device, a facsimile device, a computing device, a storage device, and the like.

Once the input document is received, the input document is processed to determine the different types of data represented by the plurality of pixels of the image data using existing segmentation techniques. For example, the image data may include pixels representing, but not limited to, text, edge, background, and pictorial (non-text area) information. As per the present subject matter, any number of segmentation methods or techniques may be used for the determination of the types of data represented by the plurality of the pixels of the image data. Then, based on the determined types of data represented by the plurality of pixels, the segmentation methods or techniques segment the input document into an image layer and a text layer. The image layer includes the background and non-textual information, while the text layer includes the textual information.

The application of segmentation methods or techniques is followed by a processing step of determining whether the image layer includes one or more image contents. In case the image layer includes more than one image contents, the one or more image contents are grouped to generate a grouped image content, which is then lifted and placed over a blank or white background image layer using a morphological operation. In this manner, a new image layer is generated.

Then, both the (original) text layer and the new image layer are separately compressed using any of the binary compression schemes. With the addition of the new image layer to the original text layer and compressing both layer with a binary compression scheme, not only improves text quality but may also provide opportunities for file size reduction (i.e., efficient data compression).

After completion of the compression, the (original) text layer and the new image layer are integrated to generate to produce the image data in the MRC file format. The image data in the MRC file format is then stored into a memory device.

The present subject matter may further optionally include additional steps, which are not meant to be limiting. For example, after the compression and storage, the image data may be optionally decompressed and output by an output device. The output device may be any type of device that is designed to output the image data. Examples of the output device may include, but not limited to, display, copy, print, or send the image data. Such output devices may further include a multifunctional device (MFD) or a printer.

### Exemplary Implementations

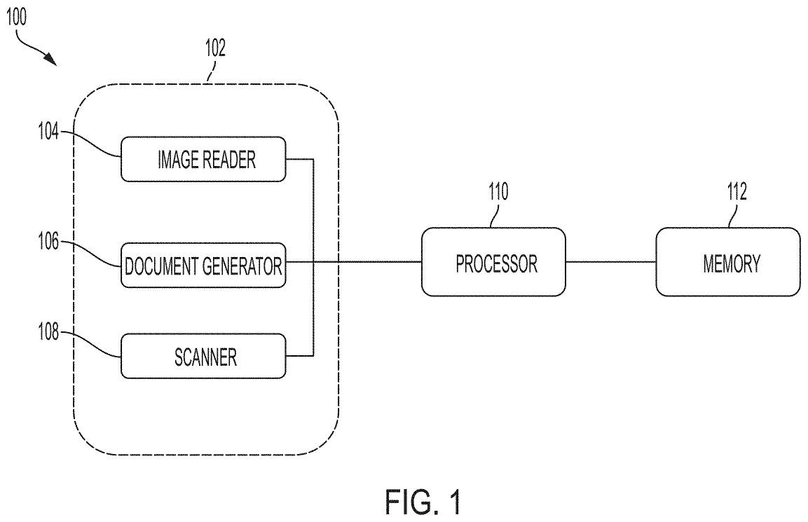

FIG. 1 illustrates an image processing system 100 as per an implementation of the present subject matter. The image processing system 100 employs an image capturing device 102 to read or otherwise receive an input document or image, optionally, a full-color document or image. The image capturing device 102 may include one or more suitable input devices such as an electronically or otherwise stored image reader 104 which reads the input document or image as pixels or digital image data, a computer image or document generator 106 which generates the input document or image as pixels or digital image data, a scanner 108 which optically scans images, printed text, handwriting or an object and converts it to a digital image data, or the like. Such digitized image data exists as a file on a computer network or a document management/processing network.

The image data of the input document is then processed by a processor 110 coupled to the image capturing device 102. The processor 110, amongst other capabilities, may be configured to fetch and execute computer-readable instructions stored in a memory 112. The processor 110 may be implemented as one or more microprocessors, microcomputers, microcontrollers, digital signal processors, central processing units, state machines, logic circuitries, and/or any devices that manipulate signals based on operational instructions. The functions of the various elements shown in the figure, including any functional blocks labeled as the processor(s), may be provided through the use of dedicated hardware as well as hardware capable of executing software in association with appropriate software.

When provided by the processor 110, the functions may be provided by a single dedicated processor, by a single shared processor, or by a plurality of individual processors, some of which may be shared. Moreover, explicit use of the term “processor” should not be construed to refer exclusively to hardware capable of executing software, and may implicitly include, without limitation, digital signal processor (DSP) hardware, network processor, application specific integrated circuit (ASIC), field programmable gate array (FPGA), read-only memory (ROM) for storing software, random access memory (RAM), non-volatile storage. Other hardware, conventional and/or custom, may also be included.

Returning to the present subject matter, the processor 110 carries out segmentation followed by an MRC compression on the image data. Once the segmentation and compression of the received image data are completed, the compressed image data is output by the processor 110. The image data is then electronically stored in the memory 112 or an otherwise appropriated storage device. Alternately, the image data is stored optically or magnetically on a disk or tape. In any event, the compressed document or image is readily accessed and/or transported over the network in the usual manner. Further, as mentioned above in the present disclosure, prior to rendering by an appropriate rendering engine or device, such as a printer, display monitor, digital copier, fax machine, and the like, the compressed image data is first decompressed or otherwise reconstructed in the usual manner.

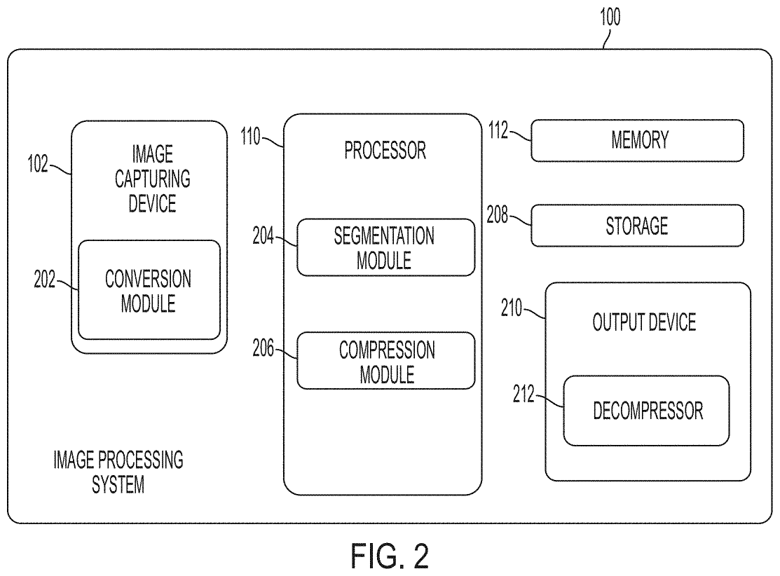

The image processing system 100 and the processes associated with the image processing system 100 are shown and described with reference to FIG. 2, in accordance with an implementation of the present disclosure. In FIG. 2, the image processing system 100 includes a number of devices for processing of image data. In an exemplary implementation, each of the devices shown in the image processing system 100 may also be considered as modules, and, therefore, the terms “device” and “module” are used interchangeably hereinafter. Further, the “devices” or “modules” illustrated in FIG. 2 are not meant to be limiting.

As per the implementation shown in FIG. 2, the image capturing device 102 of the image processing system 100 is configured to receive image data as an input document. In an example, the image capturing device 102 may be an input device. The image capturing device 102 may be any type of device for receiving the image data. Examples of the image capturing device 102 may include, but not limited to, a scanning device, a facsimile device, a computing device, a storage device, and the like.

In an implementation, the image capturing device 102 may include a conversion module 202 for converting the received image data, such as converting gray scale image data from an input device color space, such as RGB (red, green, blue), to a device independent processing color space, such as YCC/YC_{B}C_{R} (where Y′ is the luma component and C_{B} and C_{R} are the blue-difference and red-difference chrorna components) or LAB (where L for lightness and a and b for the color opponents green-red and blue-yellow) color space, where intensity and color information (i.e., luminance and chrominance) are separated. Generally, the types of color spaces for image data and the conversion of such color spaces are known in the art. The conversion module 202 may be a part of the image capturing device 102 or a separate device or module, without deviating from the scope of the present subject matter.

As discussed above in the present disclosure, the received image data comprises a plurality of pixels. The plurality of pixels of the image data is processed by a segmentation module 204 of the processor 110 in order to separate or segment the image data signal (or input data) into different layers. The segmentation module 204 segments the image data for compression. In an implementation, the segmentation module 204 may be configured to segment and optionally tag the image data (e.g., each of its pixels) to identify the types of data represented before a compression scheme is determined and/or selected. For example, based on the tag information associated with the image data, the segmentation module 204 generally segments the image data into an image layer and a text layer. The image layer includes the background and non-textual information, while the text layer includes the textual information. The image layer and the text layer are then compressed using standard compression schemes and are integrated in accordance with MRC compression scheme using a compression module 206 of the processor 110.

After completion of the compression by the compression module 206, the image layer and the text layer are integrated and processed by the processor 110. The processor 110 may be coupled to a combination of image processing elements or modules (not shown in the Figures) which comprise software and hardware elements that may perform a number of operations on the image data received from the image capturing device 102 using a set of parameters. The set of parameters may be used to convert the integrated layers to a format desired as output (e.g., high quality) along with an image path. In an example, the integrated layers are converted to MRC file format. The elements may be a part of a computer system, device, or apparatus such as a photocopier, a printing device, or a multi-function device (MFD).

The MRC file format data is then provided by or stored by the processor 110 in the memory 112 or the storage 208. From the memory 112 or the storage 208, an output device 210 may be provided to output the image data. The output device 210 may be any type of device that is designed to output the image data. For example, the output device 210 may display, copy, print, or send the image data. Examples of the output device 210 may include, but not limited to, an MFD, printer, copier, scanner, facsimile device, display, a terminal, an image storage system, and CPU.

In an implementation, the output device 210 may decompress the image data and its information before output. For decompression, the image processing system 100 or the output device 210 may include a decompressor 212 to decompress the image data before sending the image data to a rendering engine of the output device 210. The decompressor 212 and the output device 210 may be the same module, or separate modules, without deviating from the scope of the present subject matter.

Furthermore, the image processing system 100 described with reference to FIG. 2 may implement a new compression scheme in accordance with the present subject matter disclosed herein, to improve the text representation quality of output of the image processing system 100.

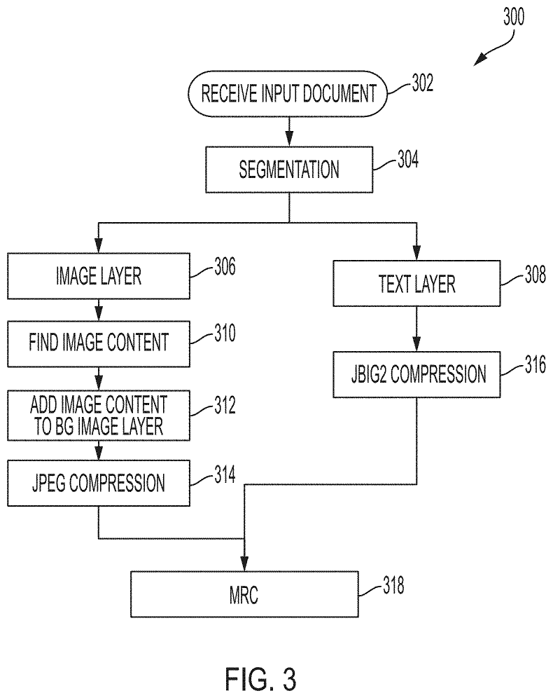

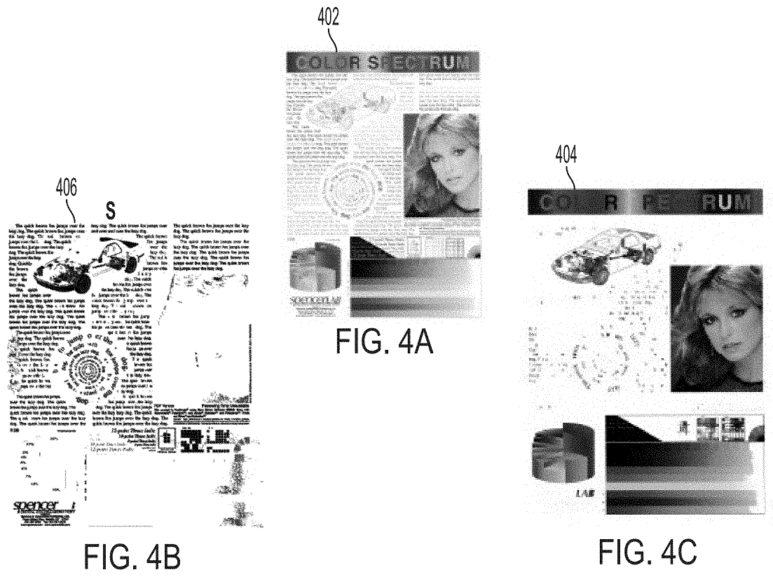

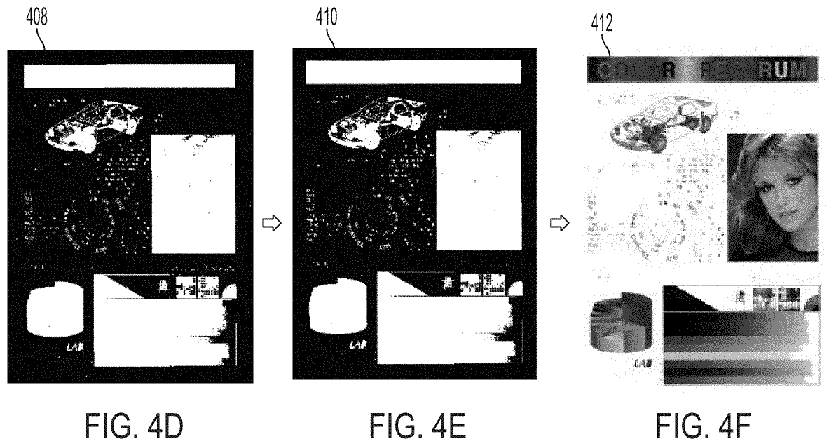

FIG. 3 illustrates a new compression scheme 300 with exemplary implementation represented in FIGS. 4A-4F. As per the new compression scheme 300, the image capturing device 102 of the image processing system 100 is configured to receive image data 402 (FIG. 4A) as an input document (Step 302). Thereafter, the plurality of pixels of the image data 402 is processed by the segmentation module 204 of the processor 110 in order to separate or segment the image data signal (or input data) into different layers. The segmentation module 204 segments the image data 402 for compression (Step 304). In an implementation, the segmentation module 204 may be configured to segment and optionally tag the image data (e.g., each of its pixels) to identify the types of data represented before a compression scheme is determined and/or selected. For example, based on the tag information associated with the image data, the segmentation module 204 generally segments the image data into an image layer 404 (Step 306) and the text layer 406 (Step 308). The image layer 404 (FIG. 4C) includes the background and non-textual information, while the text layer 406 (FIG. 4B) includes the textual information.

However, it is generally known that in the MRC compression scheme, some of the text regions will be misclassified as image region due to segmentation failures. This will introduce JPEG compression blocking artifacts near the text regions. This further creates noisy appearance around the text regions. These noises will be also contributing to an increase in the file size.

In order to remove the noises around the text regions, the new compression scheme 300 shown in FIG. 3 is implemented in the image processing system 100 in accordance with the present subject matter disclosed herein. As per the new compression scheme 300, the segmentation module 204 in association with the processor 110 determines/finds image content in the image layer (Step 310).

In case the image layer includes more than one image contents, the image contents are grouped to generate grouped image content. Then, a new image layer is generated by adding the image content or the grouped image content to a blank or white background image layer (Step 312) using a morphological operation. For instance, as shown in FIGS. 4D-4F, the morphological operation includes transforming, in the image layer 408, the determined content into white color while other regions into black color (FIG. 4D), and then dilating the image layer 410 (FIG. 4E) by extending edge and boundary regions of the determined image content so as to generate the new image layer 412 (FIG. 4F) with reduced artifacts. Thus, with the new compression scheme 300, the noises are removed using the morphological operation (dilation), only the significant image contents are moved to the blank or white background image layer.

Thereafter, the respective compression schemes are applied by the compression module 206 of the processor 110. As per the compression schemes, the new image layer is compressed using standard contone compression schemes such as JPEG (314), while the text layer is compressed using any of the binary compression schemes such as JBIG2 (316). Thereafter, compressed image layers are integrated in accordance with MRC compression scheme to generate MRC file format (318).

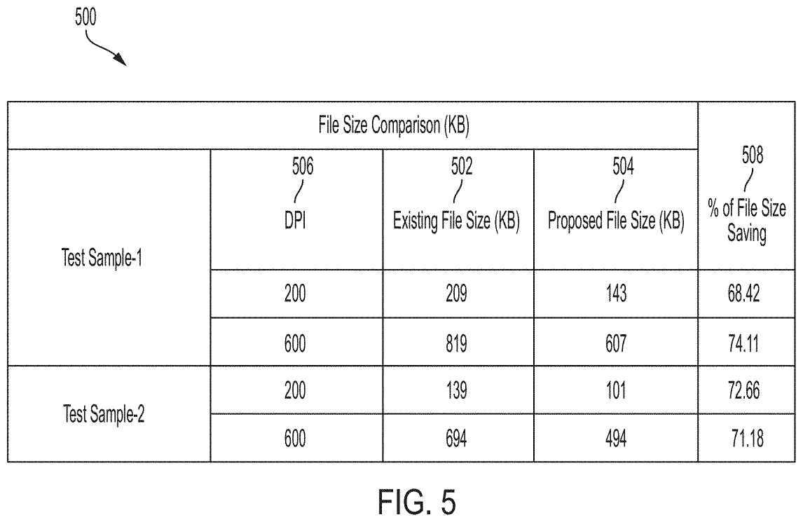

Such addition of the new image layer to the original text layer not only improves text quality but may also provide opportunities for file size reduction (i.e., efficient data compression), as can be seen from comparison table chart shown in FIG. 5.

FIG. 5 shows a comparison table chart 500 showing the comparison between the file size output (Existing File Size 502) of the conventional compression scheme and file size output (Proposed File Size 504) of the present/new compression scheme 300 of the present disclosure. The comparison between the file size output of the conventional compression scheme and the present/new compression scheme clearly show that under various output resolutions (dot per inch (DPI) 506, the file size output of the present/new compression scheme 300 is smaller than file size output of the conventional compression scheme. The column 508 indicates percentage of file size saving according to the present disclosure.

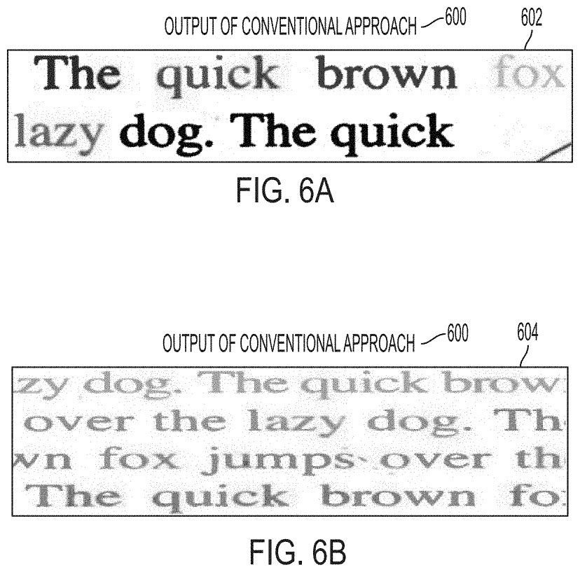

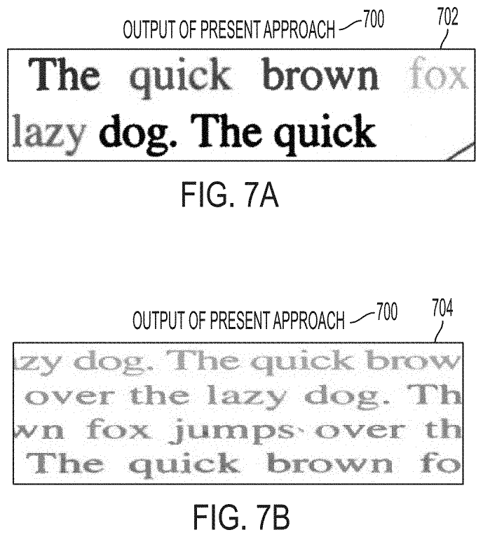

Thus, with the implementation of the present subject matter, the image data is output using the various approaches and implementations of the present subject matter with reduced or no compression artifacts, as can be seen from the comparison of output 600 (refer to FIGS. 6A and 6B) generated by conventional compression scheme, with output 700 (refer to FIGS. 7A and 7B) of the proposed compression scheme 300 of the present disclosure discussed above in FIGS. 3 and 4.

For example, in an output image 602 and 604 shown in FIGS. 6A and 6B, artifacts near the texts are clearly visible with the implementation of the conventional compression scheme. However, on the other hand, in an output images 702 and 704 shown in FIGS. 7A and 7B, no artifacts are present near texts with the implementation of the present/new compression scheme 300. This improves the clarity and quality of the output image.

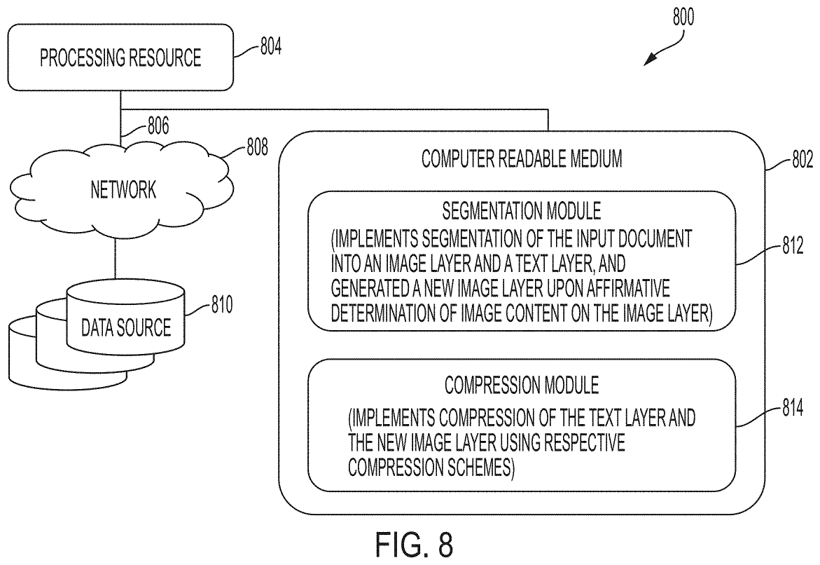

FIG. 8 illustrates an example of network environment 800 using a non-transitory computer-readable medium 802 for performing the operation of the image processing system 100, according to an implementation of the present subject matter. The network environment 800 may be a public networking environment or a private networking environment. In one example, the network environment 800 includes a processing resource 804 communicatively coupled to the non-transitory computer readable medium 802 through a communication link 806.

For example, the processing resource 804 can be a processor, such as the control device of the image processing system 100. The non-transitory computer-readable medium 802 can be, for example, an internal memory device or an external memory device. In one example, the communication link 806 may be a direct communication link, such as one formed through a memory read/write interface. In another example, the communication link 806 may be an indirect communication link, such as one formed through a network interface. In such a case, the processing resource 804 can access the non-transitory computer readable medium 802 through a network 808. The network 808 may be a single network or a combination of multiple networks and may use a variety of communication protocols.

The processing resource 804 and the non-transitory computer readable medium 802 may also be communicatively coupled to data sources 810 over the network 808. The data sources 810 can include, for example, databases and computing devices. The data sources 810 may be used by the database administrators and other users to communicate with the processing resource 804.

In one example, the non-transitory computer-readable medium 802 can include a set of computer readable instructions, such as a segmentation module 812 and a compression module 814. The set of computer readable instructions referred to as instructions hereinafter, can be accessed by the processing resource 804 through the communication link 806 and subsequently executed to perform acts for network service insertion. In other words, during operation, the processing resource 804 can execute the segmentation module 812 and the compression module 814.

On execution by the processing resource 804, the segmentation module 812 can receive an image data including a plurality of pixels. The plurality of pixels of the image data is processed by the segmentation module 812 in order to separate or segment the image data signal (or image data) into different layers. In an implementation, the segmentation module 812 may be configured to segment and optionally tag the image data (e.g., each of its pixels) to identify the types of data represented before a compression scheme is determined and/or selected. For example, based on the tag information associated with the image data, the segmentation module 812 generally segments the image data into an image layer and a text layer. The image layer includes the background and non-textual information, while the text layer includes the textual information.

Further, as per the implementation of the present subject matter, prior to generation of the different image and text layers, the segmentation module 812 in association with the processing resource 804 determines whether the image layer includes image contents.

In case the image layer comprises image contents, the compression module 814 adds the image contents to a blank or white background image layer and applies the morphological operation on the white background image layer having the determined image content to generate a new image layer. In an aspect, the morphological operation includes transforming, in the image layer, the determined content into white color while other regions into a black color, and then dilating the image layer by extending edge and boundary regions of the determined image content so as to generate the new image layer with reduced artifacts. Thus, with the new compression scheme 300, the noises are removed using the morphological operation (dilation), only the significant image contents are moved to the blank or white background image layer.

Then, both the (original) text layer and the new image layer are compressed using the respective compression schemes. As per the compression schemes, the new image layer is compressed using standard contone compression schemes such as JPEG, while the text layer is compressed using any of the binary compression schemes such as JBIG2.

Further, such addition of the new image layer to the original text layer not only improves text quality but may also provide opportunities for file size reduction (i.e., efficient data compression).

After completion of the compression, the (original) text layer and the new image layer are integrated to generate to produce the image data in the MRC file format. The image data in the MRC file format is then stored into a memory device.

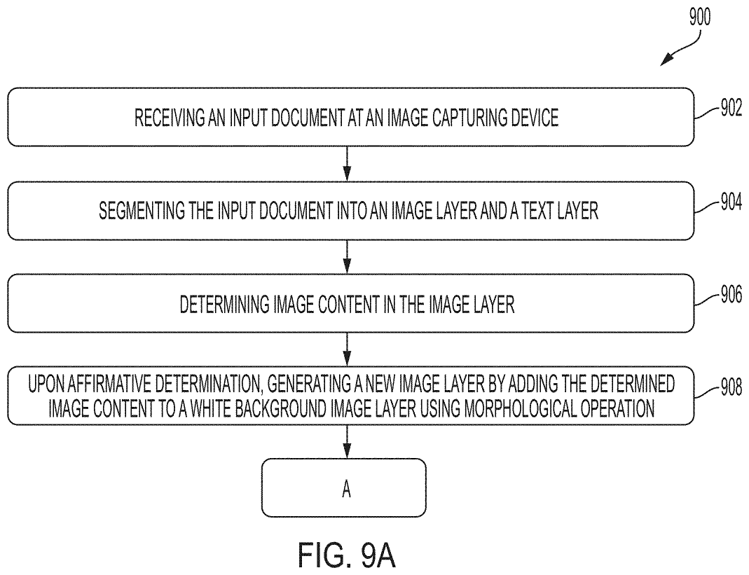

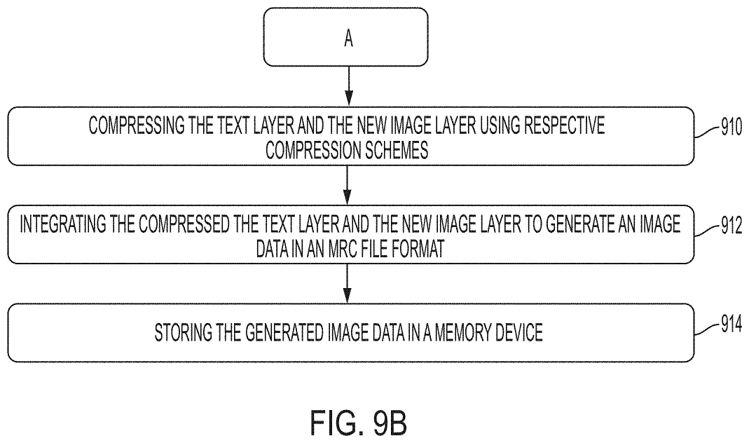

Method 900 is described in FIGS. 9A and 9B for operating the image processing system 100, according to an implementation of the present subject matter. The order in which the method 900 is described is not intended to be construed as a limitation, and any number of the described method blocks can be combined in any appropriate order to carry out the method 900 or an alternative method. Additionally, individual blocks may be deleted from the method 900 without departing from the scope of the subject matter described herein.

The method 900 can be performed by programmed computing devices, for example, based on instructions retrieved from the non-transitory computer-readable medium or non-transitory computer-readable media. The computer-readable media can include machine-executable or computer-executable instructions to perform all or portions of the described method. The computer readable media may be, for example, digital memories, magnetic storage media, such as magnetic disks and magnetic tapes, hard drives, or optically readable data storage media.

Referring to FIGS. 9A and 9B, the method 900 may be performed by a processing device, such as the processor 110 of the image processing system 102.

At block 902, the image processing system 100 receives an input document having image data including a plurality of pixels. The image data may be received as the input document by, for example, the image capturing device 102, or retrieved from the storage 208 or the memory 112. In an example, the image capturing device 102 may be an input device. The image capturing device may be any type of device for receiving input image data. Example, of the image capturing device 102, may include, but not limited to, a scanning device, a facsimile device, a computing device, a storage device, and the like.

At block 904, once the input document is received, the input document is processed to determine the different types of data represented by the plurality of pixels of the image data using existing segmentation techniques. For example, the image data may include pixels representing, but not limited to, text, edge, background, and pictorial (non-text area) information. As per the present subject matter, any number of segmentation methods may be implemented to segment the input data having the image data into an image layer and a text layer.

At block 906, the application of segmentation methods or techniques is followed by a processing step of determining whether the image layer includes an image content.

At block 908, in case the image layer includes the image content, a new image layer is generated by adding the determined image content to a blank or white background image layer using a morphological operation. For instance, as shown in FIGS. 4D-4F, the morphological operation includes transforming, in the image layer 408, the determined content into white color while other regions into black color (FIG. 4D), and then dilating the image layer 410 (FIG. 4E) by extending edge and boundary regions of the determined image content so as to generate the new image layer 412 (FIG. 4F) with reduced artifacts. Thus, with the new compression scheme 300, the noises are removed using the morphological operation (dilation), only the significant image contents are moved to the blank or white background image layer.

At block 910, both the (original) text layer and the new image layer are compressed using respective compression schemes. With the addition of the new image layer to the original text layer and compressing both layer with respective compression schemes, not only improves text quality but may also provide opportunities for file size reduction (i.e., efficient data compression).

At block 912, after completion of the compression schemes, the (original) text layer and the new image layer are integrated and processed by the processor 110 to generate an image data in the MRC file format. The processor 110 may be coupled to a combination of image processing elements or modules (not shown in Figures) which comprise software and hardware elements that may perform a number of operations on the image data received from the image capturing device 102 using a set of parameters. The set of parameters may be used to convert the integrated layers to a format desired as output (e.g., high quality) along with an image path. In an example, the integrated layers are converted to MRC file format.

At block 914, the MRC file format data is provided by or stored by the processor 110 in the memory 112 or the storage 208. From the memory 112 or the storage 208, an output device 210 may be provided to output the image data. The output device 210 may be any type of device that is designed to output the image data. For example, the output device 210 may display, copy, print, or send the image data. Examples of the output device 210 may include, but not limited to, an MFD, a printer, a copier, a scanner, a facsimile device, display, a terminal, an image storage system, and a CPU.

At time of extraction, the method includes: extracting the MRC file format from the memory device or from the storage to retrieve the compressed text layer and the compressed new image layer; decompressing the MRC file format; and transmitting the decompressed MRC file format to an output device. The MRC file format is extracted when a user wishes to view the file, copy the file, print the file, send the file or the like.

The method may be implemented in the form of a non-transitory computer-readable medium including instructions executable by a processing resource. The processing resource performs the method blocks 902-914 and other method blocks for implementing the current disclosure.

Further, the present subject matter is disclosed herein with reference to an image processing architecture; however, the subject matter is equally applicable to printing systems implemented in multi-functional devices, such as printers, copiers, and the like, which are in direct communication with the user devices.

The methods and systems of the present disclosure reduce file size and further improve image quality by removing compression artifacts when documents with color backgrounds are scanned.

The present disclosure proposes to reduce stored image size of scanned images. This is performed by lifting foreground content and then placing over a blank/white background. The disclosure proposes reduction in size of stored images without a reduction in image quality. The disclosure may be implemented for real-time scanning or may be implemented as offline tool to improve the image quality and optimize the file size.

The present disclosure may be implemented while scanning an input document. The “MRC” format is a file format including content in the form of an image layer and text layer and on such popular format is PDF, without any limitation. An image processing system receives an input document for scanning and processes the document to generate the digital document, in an MRC file format. The “input document” may be in physical form, such as printed on paper and may include content such as text, image, or a combination thereof. The content may be referred to as image data or image data may be generated upon scanning. The term “digital document” refers to a document in a virtual or software form (embodied in a software file). The virtual form can also be referred to as digital form, electronic version or the like. The digital document is in a PDF form. The PDF may be generated in an MRC file format. In the MRC file format, image content and text content are stored separately as separate layers i.e., image content is stored as an image layer, while the text content is stored as a text layer. Morphological operation refers to a number of image processing operations based on shapes.

For a person skilled in the art, it is understood that the use of phrase(s) “is,” “are,” “may,” “can,” “could,” “will,” “should,” or the like, is for understanding various embodiments of the present disclosure and the phrases do not limit the disclosure or its implementation in any manner.

The order in which the method is described is not intended to be construed as a limitation, and any number of the described method blocks can be combined in any order to implement the method or alternate methods. Additionally, individual blocks may be deleted from the method without departing from the spirit and scope of the subject matter described herein. Furthermore, the method can be implemented in any suitable hardware, software, firmware, or combination thereof. However, for ease of explanation, in the embodiments described below, the method may be considered to be implemented in the above described system and/or the apparatus and/or any electronic device (not shown).

The above description does not provide specific details of manufacture or design of the various components. Those of skill in the art are familiar with such details, and unless departures from those techniques are set out, techniques, known, related art or later developed designs and materials should be employed. Those in the art are capable of choosing suitable manufacturing and design details.

Note that throughout the following discussion, numerous references may be made regarding servers, services, engines, modules, interfaces, portals, platforms, or other systems formed from computing devices. It should be appreciated that the use of such terms is deemed to represent one or more computing devices having at least one processor configured to or programmed to execute software instructions stored on a computer readable tangible, non-transitory medium or also referred to as a processor-readable medium. For example, a server can include one or more computers operating as a web server, database server, or other type of computer server in a manner to fulfill described roles, responsibilities, or functions. Within the context of this document, the disclosed devices or systems are also deemed to comprise computing devices having a processor and a non-transitory memory storing instructions executable by the processor that cause the device to control, manage, or otherwise manipulate the features of the devices or systems.

Some portions of the detailed description herein are presented in terms of algorithms and symbolic representations of operations on data bits performed by conventional computer components, including a central processing unit (CPU), memory storage devices for the CPU, and connected display devices. These algorithmic descriptions and representations are the means used by those skilled in the data processing arts to most effectively convey the substance of their work to others skilled in the art. An algorithm is generally perceived as a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be understood, however, that all of these and similar terms are to be associated with the appropriate physical quantities and are merely convenient labels applied to these quantities. Unless specifically stated otherwise, as apparent from the discussion herein, it is appreciated that throughout the description, discussions utilizing terms such as “segmenting,” or “receiving,” or “compressing,” or “storing,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The exemplary embodiment also relates to an apparatus for performing the operations discussed herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general-purpose systems may be used with programs in accordance with the teachings herein, or it may prove convenient to construct more specialized apparatus to perform the methods described herein. The structure for a variety of these systems is apparent from the description above. In addition, the exemplary embodiment is not described with reference to any particular programming language. It will be appreciated that a variety of programming languages may be used to implement the teachings of the exemplary embodiment as described herein.

The methods illustrated throughout the specification, may be implemented in a computer program product that may be executed on a computer. The computer program product may comprise a non-transitory computer-readable recording medium on which a control program is recorded, such as a disk, hard drive, or the like. Common forms of non-transitory computer-readable media include, for example, floppy disks, flexible disks, hard disks, magnetic tape, or any other magnetic storage medium, CD-ROM, DVD, or any other optical medium, a RAM, a PROM, an EPROM, a FLASH-EPROM, or other memory chip or cartridge, or any other tangible medium from which a computer can read and use.

Alternatively, the method may be implemented in transitory media, such as a transmittable carrier wave in which the control program is embodied as a data signal using transmission media, such as acoustic or light waves, such as those generated during radio wave and infrared data communications, and the like.

The terminology used herein is for the purpose of describing particular embodiments only and is not intended to be limiting of the disclosure. It will be appreciated that several of the above-disclosed and other features and functions, or alternatives thereof, may be combined into other systems or applications. Various presently unforeseen or unanticipated alternatives, modifications, variations, or improvements therein may subsequently be made by those skilled in the art without departing from the scope of the present disclosure as encompassed by the following claims.

The claims, as originally presented and as they may be amended, encompass variations, alternatives, modifications, improvements, equivalents, and substantial equivalents of the embodiments and teachings disclosed herein, including those that are presently unforeseen or unappreciated, and that, for example, may arise from applicants/patentees and others.

It will be appreciated that variants of the above-disclosed and other features and functions, or alternatives thereof, may be combined into many other different systems or applications. Various presently unforeseen or unanticipated alternatives, modifications, variations, or improvements therein may be subsequently made by those skilled in the art which are also intended to be encompassed by the following claims.

What is claimed is:

1. A method for generating a mixed raster content (MRC) format file, comprising:
receiving an input document at an image capturing device;
segmenting the input document into an image layer and a text layer;
determining whether the image layer includes image content;
upon affirmative determination that the image layer includes one or more image contents, generating a new image layer by grouping the one or more image contents to generate grouped image content, and adding the grouped image content to a white background image layer using a morphological operation;
compressing the text layer and the new image layer using respective compression schemes;
after completing of the compression, integrating the compressed the text layer and the new image layer to generate an image data in the MRC file format; and
storing the generated image data in a memory device.

2. The method as claimed in claim 1, wherein compressing the text layer and the new image layer using respective compression schemes, comprising:
compressing the text layer using a first compression scheme; and
compressing the new image layer using a second compression scheme.

3. The method as claimed in claim 2, wherein the first compression scheme is a binary compression scheme.

4. The method as claimed in claim 3, wherein the binary compression scheme is JBIG2 compression.

5. The method as claimed in claim 2, wherein the second compression scheme is a standard contone compression scheme.

6. The method as claimed in claim 5, wherein the standard contone compression scheme comprises JPEG compression.

7. The method as claimed in claim 1, wherein the morphological operation comprising:
transforming, in the image layer, the determined content into white color while other regions into black color; and
dilating the image layer by extending edge and boundary regions of the determined image content.

8. The method as claimed in claim 1, further comprising:
extracting the MRC file format from the memory device to retrieve the compressed text layer and the compressed new image layer;
decompressing the MRC file format; and
transmitting the decompressed MRC file format to an output device.

9. An image processing system for generating a mixed raster content (MRC) format file, the image processing system comprising:
an image capturing device to receive an input;
a processor coupled to the image capturing device;
a segmentation module, coupled to the processor, to segment the input document into an image layer and a text layer; and
a compression module, coupled to the processor, to:
determine whether the image layer includes image content;
upon affirmative determination that the image layer includes one or more image contents, generate a new image layer by grouping the one or more image contents to generate grouped image content, and adding the grouped image content to a white background image layer using a morphological operation;
compress the text layer and the new image layer using respective compression schemes;
after completion of the compression, integrate the compressed the text layer and the new image layer to generate an image data in the MRC file format; and
store the generated image data in a memory device.

10. The image processing system as claimed in claim 9, wherein for compressing the text layer and the new image layer, the compression module is to:
compress the text layer using a first compression scheme; and
compress the new image layer using a second compression scheme.

11. The image processing system as claimed in claim 10, wherein the first compression scheme is a binary compression scheme.

12. The image processing system as claimed in claim 11, wherein the binary compression scheme is JBIG2 compression.

13. The image processing system as claimed in claim 10, wherein the second compression scheme is a standard contone compression scheme.

14. The image processing system as claimed in claim 13, wherein the standard contone compression scheme comprises JPEG compression.

15. The image processing system as claimed in claim 9, wherein the morphological operation comprising:
transforming, in the image layer, the determined content into white color while other regions into black color; and
dilating the image layer by extending edge and boundary regions of the determined image content.

16. The image processing system as claimed in claim 9, wherein the compression module is to:
extract the image data in the MRC file format from the memory device to retrieve the compressed text layer and the compressed new image layer;
decompressing the image data present in the MRC file format; and
transmitting the decompressed the image data present in the MRC file format to an output device.

17. A non-transitory computer-readable medium comprising instructions executable by a processing resource to:
receive an input document;
segment the input document into an image layer and a text layer;
determine whether the image layer includes image content;
upon affirmative determination that the image layer includes one or more image contents, generate a new image layer by grouping the one or more image contents to generate grouped image content, and adding the grouped image content to a white background image layer using a morphological operation;
compress the text layer and the new image layer using respective compression schemes;
after completion of the compression, integrate the compressed the text layer and the new image layer to generate an image data in the MRC file format; and
store the generated image data in a memory device.

18. The non-transitory computer-readable medium of claim 17 comprising instructions executable by the processing resource to:
compress the text layer using a first compression scheme; and
compress the new image layer using a second compression scheme.

19. The non-transitory computer-readable medium as claimed in claim 18, wherein the first compression scheme is a binary compression scheme.

20. The non-transitory computer-readable medium as claimed in claim 19, wherein the binary compression scheme is JBIG2 compression.

21. The non-transitory computer-readable medium as claimed in claim 18, wherein the second compression scheme is a standard contone compression scheme.

22. The non-transitory computer-readable medium as claimed in claim 21, wherein the standard contone compression scheme comprises JPEG compression.

23. The non-transitory computer-readable medium of claim 17, wherein the morphological operation comprising:
transforming, in the image layer, the determined content into white color while other regions into black color; and
dilating the image layer by extending edge and boundary regions of the determined image content.

24. The non-transitory computer-readable medium of claim 17 comprising instructions executable by the processing resource to:
extract the image data in the MRC file format from the memory device to retrieve the compressed text layer and the compressed image layer;
decompress the image data present in the MRC file format; and
transmit the decompressed the image data present in the MRC file format to an output device.
